(19) United States
(12) Patent Application Publication
(10) Pub. No.: US 2002/0193074 A1
(43) Pub. Date: Dec. 19, 2002

(54) Service system usage control

(75) Inventor: Robert Francis Squibbs, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD COMPANY

(21) Appl. No.: 10/143,101

(22) Filed: May 7, 2002

(30) Foreign Application Priority Data
Jun. 14, 2001 (GB) 0114425.2

(51) Int. Cl. H04B 1/00

(52) U.S. Cl. 455/45; 455/414

(57) ABSTRACT

In order to encourage listeners to remain tuned to a particular radio station, loyal listeners are rewarded by being enabled to use a service system accessible via a data-capable bearer service of a communications infrastructure. This is achieved by periodically including, amongst the material broadcast by the radio station, a variable-value access code and then only servicing request to the service system that include the most recent value of the access code. The listener takes advantage of the service by extracting the access code value from the received radio signal and including it in a service request. Typically, the service is a location-based service accessible by a mobile listener via a cellular radio network.

### FIELD OF THE INVENTION

The present invention relates to a method and apparatus for providing controlled usage of a service system by recipients of a broadcast radio channel.

### BACKGROUND OF THE INVENTION

Communication infrastructures suitable for mobile users (in particular, though not exclusively, cellular radio infrastructures) have now become widely adopted. Whilst the primary driver has been mobile telephony, the desire to implement mobile data-based services over these infrastructures, has led to the rapid development of data-capable bearer services across such infrastructures. This has opened up the possibility of many Internet-based services being available to mobile users.

By way of example, FIG. 1 shows one form of known communication infrastructure for mobile users providing both telephony and data-bearer services. In this example, a mobile entity 20, provided with a radio subsystem 22 and a phone subsystem 23, communicates with the fixed infrastructure of GSM PLMN (Public Land Mobile Network) 10 to provide basic voice telephony services. In addition, the mobile entity 20 includes a data-handling subsystem 25 interworking, via data interface 24, with the radio subsystem 22 for the transmission and reception of data over a data-capable bearer service provided by the PLMN; the data-capable bearer service enables the mobile entity 20 to communicate with a service system 40 connected to the public Internet 39. The data handling subsystem 25 supports an operating environment 26 in which applications run, the operating environment including an appropriate communications stack.

More particularly, the fixed infrastructure 10 of the GSM PLMN comprises one or more Base Station Subsystems (BSS) 11 and a Network and Switching Subsystem NSS 12. Each BSS 11 comprises a Base Station Controller (BSC) 14 controlling multiple Base Transceiver Stations (BTS) 13 each associated with a respective “cell” of the radio network. When active, the radio subsystem 22 of the mobile entity 20 communicates via a radio link with the BTS 13 of the cell in which the mobile entity is currently located. As regards the NSS 12, this comprises one or more Mobile Switching Centers (MSC) 15 together with other elements such as Visitor Location Registers 32 and Home Location Register 32.

When the mobile entity 20 is used to make a normal telephone call, a traffic circuit for carrying digitised voice is set up through the relevant BSS 11 to the NSS 12 which is then responsible for routing the call to the target phone (whether in the same PLMN or in another network).

With respect to data transmission to/from the mobile entity 20, in the present example three different data-capable bearer services are depicted though other possibilities exist. A first data-capable bearer service is available in the form of a Circuit Switched Data (CSD) service; in this case a full traffic circuit is used for carrying data and the MSC 32 routes the circuit to an InterWorking Function IWF 34 the precise nature of which depends on what is connected to the other side of the IWF. Thus, IWF could be configured to provide direct access to the public Internet 39 (that is, provide functionality similar to an IAP—Internet Access Provider IAP). Alternatively, the IWF could simply be a modem connecting to a PSTN; in this case, Internet access can be achieved by connection across the PSTN to a standard IAP.

A second, low bandwidth, data-capable bearer service is available through use of the Short Message Service that passes data carried in signalling channel slots to an SMS unit which can be arranged to provide connectivity to the public Internet 39.

A third data-capable bearer service is provided in the form of GPRS (General Packet Radio Service which enables IP (or X.25) packet data to be passed from the data handling system of the mobile entity 20, via the data interface 24, radio subsystem 21 and relevant BSS 11, to a GPRS network 17 of the PLMN 10 (and vice versa). The GPRS network 17 includes a SGSN (Serving GPRS Support Node) 18 interfacing BSC 14 with the network 17, and a GGSN (Gateway GPRS Support Node) interfacing the network 17 with an external network (in this example, the public Internet 39). Full details of GPRS can be found in the ETSI (European Telecommunications Standards Institute) GSM 03.60 specification. Using GPRS, the mobile entity 20 can exchange packet data via the BSS 11 and GPRS network 17 with entities connected to the public Internet 39.

The data connection between the PLMN 10 and the Internet 39 will generally be through a firewall 35 with proxy and/or gateway functionality.

Different data-capable bearer services to those described above may be provided, the described services being simply examples of what is possible.

In FIG. 1, a service system 40 is shown connected to the Internet 40, this service system being accessible to the OS/application 26 running in the mobile entity by use of any of the data-capable bearer services described above. The data-capable bearer services could equally provide access to a service system that is within the domain of the PLMN operator or is connected to another public or private data network.

With regard to the OS/application software 26 running in the data handling subsystem 25 of the mobile entity 20, this could, for example, be a WAP application running on top of a WAP stack where “WAP” is the Wireless Application Protocol standard. Details of WAP can be found, for example, in the book “Official Wireless Application Protocol” Wireless Application Protocol Forum, Ltd published 1999 Wiley Computer Publishing. Where the OS/application software is WAP compliant, the firewall will generally also serve as a WAP proxy and gateway. Of course, OS/application 26 can comprise other functionality (for example, an e-mail client) instead of, or additional to, the WAP functionality.

The mobile entity 20 may take many different forms. For example, it could be two separate units such as a mobile phone (providing elements 22-24) and a mobile PC (data-handling system 25) coupled by an appropriate link (wireline, infrared or even short range radio system such as Bluetooth). Alternatively, mobile entity 20 could be a single unit such as a mobile phone with WAP functionality. Of course, if only data transmission/reception is required (and not voice), the phone functionality 24 can be omitted; an example of this is a PDA with built-in GSM data-capable functionality whilst another example is a digital camera (the data-handling subsystem) also with built-in GSM data-capable functionality enabling the upload of digital images from the camera to a storage server.

Whilst the above description has been given with reference to a PLMN based on GSM technology, it will be appreciated that many other cellular radio technologies exist and can typically provide the same type of functionality as described for the GSM PLMN 10.

Recently, much interest has been shown in “location-aware” services for mobile users, these being services that take account of the current location of the user (or other mobile party). Location-aware services all require user location as an input parameter. A number of methods already exist for determining the location of a mobile user as represented by an associated mobile equipment. Example location-determining methods will now be described with reference to FIGS. 2 and 3. As will be seen, some of these methods result in the user knowing their location thereby enabling them to transmit it to a location-aware service they are interested in receiving, whilst other of the methods result in the user's location becoming known to a network entity from where it can be supplied directly to a location-aware service (generally only with the consent of the user concerned). It is to be understood that additional methods to those illustrated in FIGS. 2 and 3 exist.

As well as location determination, FIGS. 2 and 3 also illustrate how the mobile entity requests a location-aware service provided by service system 40. In the present examples, the request is depicted as being passed over a cellular mobile network (PLMN 10) to the service system 40. The PLMN is, for example, similar to that depicted in FIG. 1 with the service request being made using a data-capable bearer service of the PLMN. The service system 40 may be part of the PLMN itself or connected to it through a data network such as the public Internet. It should, however, be understood that infrastructure other than a cellular network may alternatively be used for making the service request

FIG. 2 depicts several forms of GPS location-determining system. On the left-hand side of FIG. 2, a mobile entity 20A is provided with a standard GPS module and is capable of determining the location of entity 20A by picking up signals from satellites 60. The entity 20A can then supply this location when requesting, in request 61, a location-aware service from service system 40.

The right-hand side of FIG. 2 depicts, in relation to mobile entity 20B, two ways in which assistance can be provided to the entity in deriving location from GPS satellites. Firstly, the PLMN 10 can be provided with fixed GPS receivers 62 that each continuously keep track of the satellites 60 visible from the receiver and pass information in messages 63 to local mobile entities 20B as to where to look for these satellites and estimated signal arrival times; this enables the mobile entities 20B to substantially reduce acquisition time for the satellites and increase accuracy of measurement. Secondly, as an alternative enhancement, the processing load on the mobile entity 20B can be reduced and encoded jitter removed using the services of network entity 64 (in or accessible through PLMN 10).

Once the mobile unit 20B has determined its location, it can pass this information in request 65 when invoking a location-aware service provided by service system 40.

FIG. 3 depicts two general approaches to location determination from signals present in a cellular radio infrastructure. First, it can be noted that in general both the mobile entity and the network will know the identity of the cell in which the mobile entity currently resides, this information being provided as part of the normal operation of the system. (Although in a system such as GSM, the network may only store current location to a resolution of a collection of cells known as a “location area”, the actual current cell ID will generally be derivable from monitoring the signals exchanged between the BSC 14 and the mobile entity). Beyond current basic cell ID, it is possible to get a more accurate fix by measuring timing and/or directional parameters between the mobile entity and multiple BTSs 13, these measurement being done either in the network or the mobile entity.

The left-hand half of FIG. 3 depicts the case of location determination being done in the mobile entity 20C by, for example, making Observed Time Difference (OTD) measurements with respect to signals from BTSs 13 and calculating location using a knowledge of BTS locations. The location data is subsequently appended to a service request 66 sent to service system 40 in respect of a location-aware service. The calculation load on mobile entity 20C could be reduced and the need for the mobile to know BTS locations avoided, by having a network entity do some of the work. The right-hand half of FIG. 3 depicts the case of location determination being done in the network, for example, by making Timing Advance measurements for three BTSs 13 and using these measurements to derive location (this derivation typically being done in a unit associated with BSC 14). The resultant location data is passed to a location server 67 from where it can be made available to authorised services. When the mobile entity 20D of FIG. 3 wishes to invoke a location-aware service available on service system 50, it sends a request 69 including an authorisation token and its ID (possible embedded in the token) to the service system 40; the service system then uses the authorisation token to obtain the current location of the mobile entity 20G from the location server 67.

With respect to the location server 67, whilst access authorisation by location-aware services has been described as being through authorisation tokens supplied by the mobile entities concerned, other authorisation techniques can be used. In particular, a location-aware service can be prior authorised with the location server in respect of particular mobile entities; in this case, each request from the service for location data needs only to establish that the request comes from a service authorised in respect of the mobile entity for which the location data is requested.

For any service supported by commercial advertising revenue (including broadcast radio services and internet-based services), it is important for the service operator to be able to convince potential advertisers that not only does the service concerned attract a significant audience of relevance to the advertiser, but also that advertisements are presented via the service in a way that reduces the possibilities of the audience avoiding the advertisements. Precisely what techniques are employed by a service provider to maximise the potential effectiveness of advertisements depends very much on the nature of the service being offered and the medium concerned. Thus, for internet services, click-through banner ads and prize schemes are frequently employed to maximise the effectiveness of advertisements (and thus of advertising revenues to the service operator). For free-to-air broadcast radio channels (whether just sound or sound and vision), different techniques are used although generally there is significant regulation by the authorities.

It is an object of the present invention to provide a way of increasing the likelihood of the audience of a broadcast radio station remaining tuned whilst advertisements are being transmitted.

### SUMMARY OF THE INVENTION

According to one aspect of the present invention, there is provided a method of controlling use of a service system accessible via a data-capable bearer service of a communications infrastructure, the method comprising the steps of:

(a) broadcasting content via a broadcast radio channel and periodically including a variable-value access code;

(b) receiving service requests at the service system and, at least for a subset of the requests, only servicing a request where the request is accompanied by a recently broadcast access-code value.

Preferably, the request is only serviced if the accompanying access-code value is the most recently broadcast value. Advantageously, the access code is included during advertisements forming part of said content so that a party needs to receive the advertisements in order to use the service system.

According to another aspect of the present invention, there is provided a method of obtaining use of a service system accessible via a data-capable bearer service of a communications infrastructure, the method comprising the steps of:

(a) receiving a broadcast radio channel that periodically includes, along with the content being broadcast, a variable-value access code;

(b) extracting the access code from the received broadcast radio channel;

(c) sending a service request to the service system via said data-capable bearer service, the service request including a recently broadcast access-code value.

According to a further aspect of the present invention, there is provided apparatus for obtaining use of a service system accessible via a data-capable bearer service of a communications infrastructure, the apparatus comprising:

a radio receiver for receiving broadcast content that periodically includes a variable-value access code;

an extraction subsystem for extracting the access code from the received broadcast radio channel;

a request subsystem for generating a service request and sending it to the service system via said data-capable bearer service, the service request including a recently broadcast access-code value as extracted by the extraction subsystem.

According to a still further aspect of the present invention, there is provided a method of providing for controlled use of a service system accessible via a data-capable bearer service of a communications infrastructure, the method comprising the steps of:

(a) broadcasting content via a broadcast radio channel and periodically including a variable-value access code;

(b) receiving the broadcast radio channel;

(c) extracting the access code from the received broadcast radio channel;

(d) sending a service request to the service system via said data-capable bearer service, the service request including a recently broadcast access-code value; and

(e) receiving the service request at the service system and only servicing the request where the request is accompanied by a recently broadcast access-code value.

### BRIEF DESCRIPTION OF THE DRAWINGS

Embodiments of the present invention will now be described, by way of non-limiting example, with reference to the accompanying diagrammatic drawings, in which:

FIG. 1 is a diagram of a known communications infrastructure usable for transferring voice and data to/from a mobile entity;

FIG. 2 is a diagram illustrating one known approach to determining the location of a mobile entity, this approach involving the use of GPS satellites;

FIG. 3 is a diagram illustrating another known approach to determining the location of a mobile entity, this approach being based on the use of signals present in a cellular mobile radio communications system; and

FIG. 4 is a diagram illustrating an embodiment of the invention in which a mobile user extracts codes in a broadcast radio signal in order to gain access to an Internet service system via a cellular radio network.

### BEST MODE OF CARRYING OUT THE INVENTION

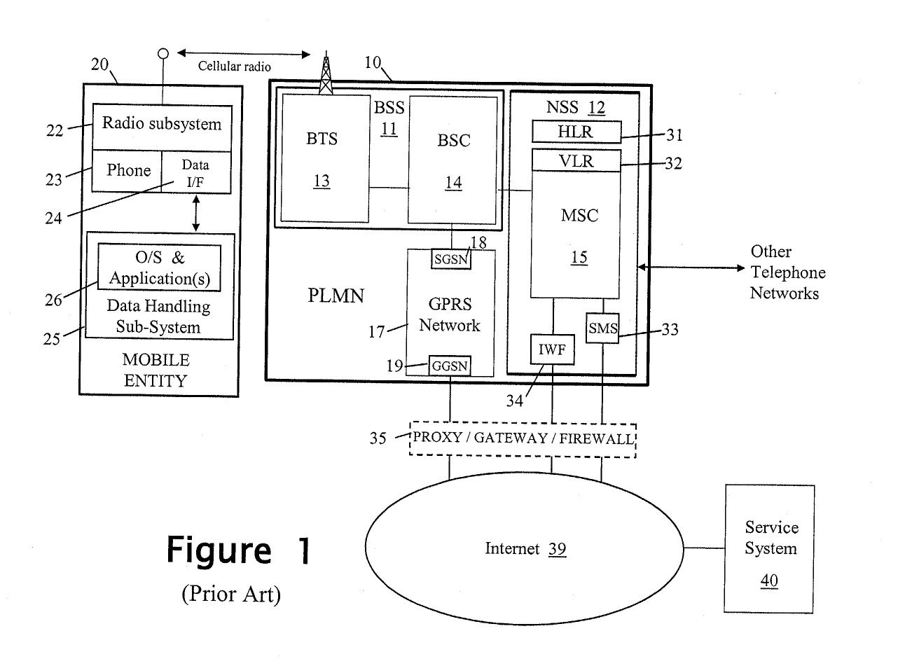

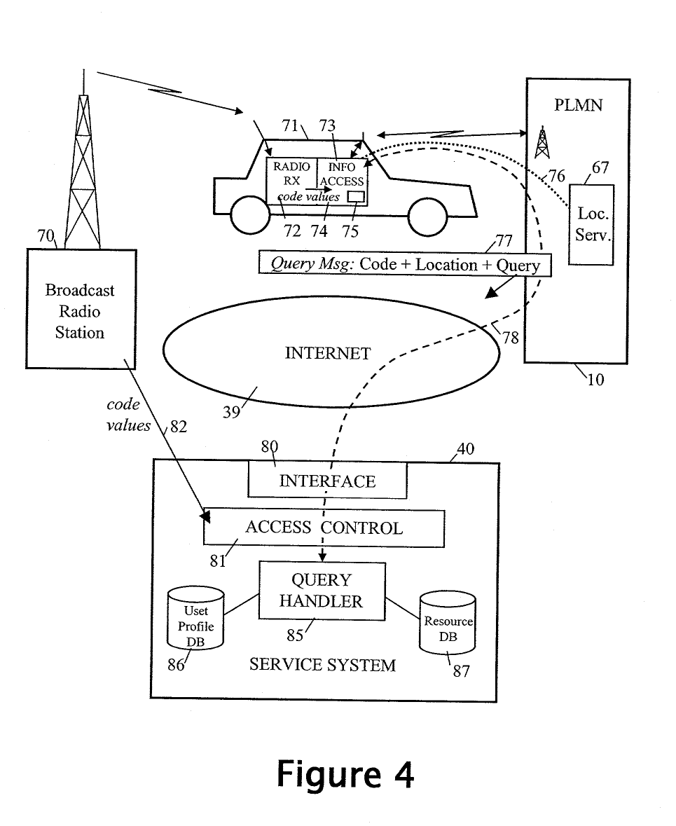

An embodiment of the present invention will now be described with reference to FIG. 4 which shows a mobile entity, here in the form of an information-access unit 73 of vehicle 71, accessing a service system 40 via PLMN 10 and the public Internet 39. It is to be understood that the present invention is not limited to the specifics of the mobile entity and communication infrastructure shown in FIG. 4 and the generalisations discussed above in relation to FIG. 1 regarding these elements apply equally to the operational context of the service system 40. Indeed, as will be apparent hereinafter, the present invention can be employed in respect not only of mobile entities such as the vehicle 71, but also static entities in which case the connection to the service system need not involve a radio link. Furthermore, whilst the service system 40 is shown as connected to the public Internet, it could be connected to the GPRS network 17 or to another fixed data network interfacing directly or indirectly with the network 17 or network 39.

The purpose of the FIG. 4 arrangement is to encourage people to listen to, or continue to listen to, commercial radio station 70 by providing current listeners access to a service provided by service system 40.

Considering FIG. 4 in more detail, broadcast radio station 70 broadcasts content (for example, popular music) that is interspersed with advertisements. The broadcast signal also periodically includes an access code the value of which is changed randomly at each inclusion; preferably, the access code is included during the transmission of each advertisement and at intervals during the course of any sponsored programs. Techniques for embedding data in broadcast radio signals are well known and are used, for example, to send station identification information that can be extracted and displayed by receiving equipment.

Vehicle 71 includes a radio receiver 72 for receiving the broadcast radio signal from the station 70. This receiver has a subsystem for extracting access codes in the received signal and passing the extracted code value 74 to the information access unit 73 together with an indication of the identity of the station 70. Unit 73 is similar to entity 20 of FIG. 1 and is capable of accessing internet 39 via a data-capable bearer service of PLMN 10 with which it is in radio communication. A data-handling subsystem of unit 73 runs an application 75 for accessing internet sites, such as service system 40, associated with radio stations; in particular, the station identity passed to the unit 73 from the radio receiver 72 is used by the application 75 to look up the internet address of the service system 40 associated with the station. This look-up can either be done using a locally-held table or by accessing an internet resource at a known address.

In the present example, the service system 40 provides a location-aware service (such as directions to the nearest facility of a specified type such as fuel, food, etc.). When a person in vehicle 71 wishes to use the service, the person specifies the types of facility to be located (for example, by use of a visual or sound-based menu system presented by a user-interface of unit 73) and then initiates the sending of the request. The application 75 thereupon requests the current location of the vehicle from a location server 67 of PLMN 10 (see arrow 76), this location server 67 operating in the same general manner as that described above with reference to FIG. 3. Once the location data is received back from the location server, the application 75 constructs a query 77 that includes the type of facility of interest, the current vehicle location, and the most recently extracted access-code value received from the radio receiver 72. The application then sends the query 77 (see arrow 78) via a data-capable bearer service of PLMN 10, and the internet 39 to the service system 40 at the address of the latter previously ascertained on the basis of the identity of the station 70.

The query 77 is received at service system 40 by interface 80 and passed to an access control unit 81. This latter is arranged to receive the access code values from station 70 as they are transmitted (for example, via dedicated line, via a radio receiver, or via the internet); alternatively, the access control unit 81 can be the source of the code values which it passes to the station 70 for broadcast. In any event, the access control unit knows the value of the most recently transmitted access code and compares this value with that in the query 77. If the values match, the query is passed to a query handler 85; otherwise the query is discarded on the basis that the party sending the query is not currently tuned to station 70 and is therefore not entitled to the use the service system 40.

Queries 77 passed to query handler 85 are processed in any appropriate manner, for example, by using the facility-type data and location data contained in the message to look up the location of the nearest facility of the specified type in database 87. If user identity is also included in the query and the party has pre-registered preferences with the service, the query handler 85 can also look up user preferences in user profile database 86. In the present example, once a response has been compiled, it is returned by query handler 85 to the information access unit 73 of vehicle 71.

In this manner, persons wishing to user the service provided by service system 40 are caused to stay tuned to station 70 in order to be able to extract the most current access-code value required to use the service.

It will be appreciated that many variants are possible to the above described embodiment of the invention. For example, since there may be a significant time delay for a query to reach the service system 40, some leeway is preferably allowed regarding the access-code value included in the query—thus, the penultimate code value can be arranged to be recognised as valid by access control unit 81 for a period of one minute after the receipt by the latter of a new code value from station 70; alternatively, the unit 81 can treated both the last received and the last-but-one received code values from station 70 as valid.

The code values can be inserted at regular or random intervals throughout the broadcast content and not just during the broadcast of advertisements or sponsored programs. In this case, code values are preferably broadcast at least once a minute or, if a more rigid regime is to be applied, once every five seconds.

Rather than the address of the service system 40 needing to be looked up by unit 73 on the basis of station identity information, this address can be included in the broadcast signal along with the access code which has the advantage that more than one service system can then be associated with the station 70. Even if a single fixed service-system address is associated with station 70, a similar effect can be achieved by having the system 40 redirect queries to other service systems based on the programming schedule of the station 70.

Whilst the service system is most likely to be run or sponsored by the operator of the broadcast radio station 70, it can alternatively be operated by another party including an advertiser or program sponsor.

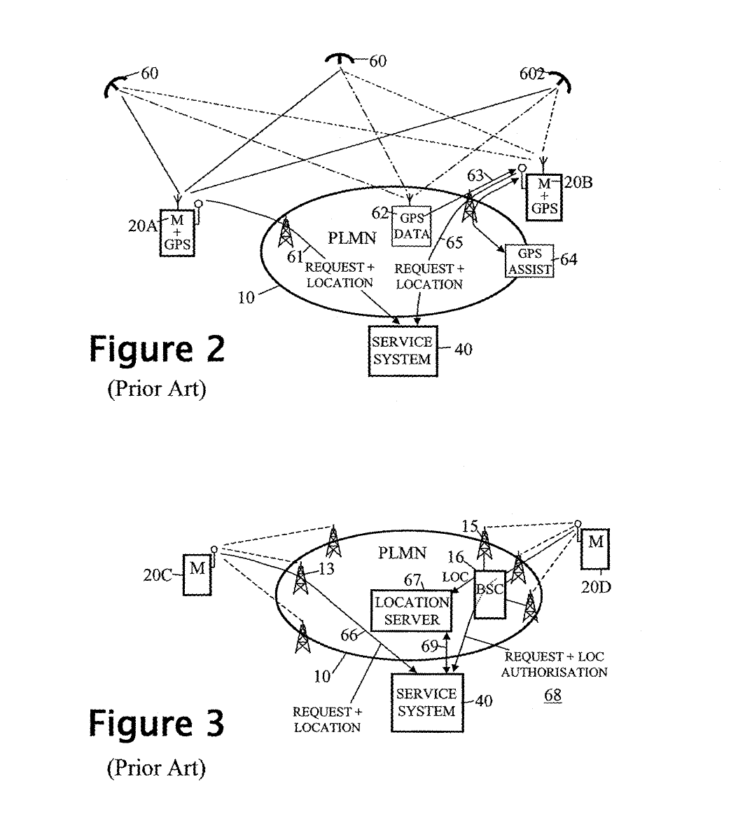

In the above example where the service provided by the service system is a location-based service, the location data was first fetched by the unit 73 before being passed to the service system 40; it will be appreciated that, instead, the service system can be authorised by the unit 73 to retrieve the location data from the location server 67 or the mobile entity can itself derive its location (for example, by the use of a GPS receiver as in FIG. 2). Of course, the service offered by the service system need not be a location based service and could, for example, be a service offering information about music played by the station 70. Furthermore, the service system can also provide its service to users who are authorised by means other than the access code values broadcast by station 70; for example, users can be pre-registered with the service system and given a specific username/password pair for gaining access to the service system.

The information access unit 73 can access the fixed communications infrastructure through means other than a cellular radio connection; for example, the unit 73 can be provided with a short-range radio subsystem such as a Bluetooth subsystem. Alternatively, the unit 73 can be static and access the service system via a wireline or cable connection rather than by a radio-based system.

As regards the broadcast radio station 70, it will be appreciated that the broadcast content can be of any nature and, indeed, is not limited to sound-signal content but can also include visual signals.

1. A method of controlling use of a service system accessible via a data-capable bearer service of a communications infrastructure, the method comprising the steps of:
(a) broadcasting content via a broadcast radio channel and periodically including a variable-value access code;
(b) receiving service requests at the service system and, at least for a subset of the requests, only servicing a request where the request is accompanied by a recently broadcast access-code value.

2. A method according to claim 1, wherein said request is only serviced if the accompanying access-code value is the most recently broadcast value.

3. A method according to claim 1, wherein in step (a) the code is accompanied by the access address of the service system.

4. A method according to claim 1, wherein the access address of the service system is pre-established for the broadcast radio channel concerned.

5. A method according to claim 1, wherein in step (a) the access code is included at least every minute.

6. A method according to claim 1, wherein in step (a) the access code is included at least every five seconds.

7. A method according to claim 1, wherein in step (a) the access code is included during advertisements forming part of said content.

8. A method according to claim 1, wherein in step (a) the access code is included at random intervals.

9. A method according to claim 1, wherein in step (a) the access code is included with content associated with a party providing or sponsoring the service system.

10. A method according to claim 1, wherein the service system is run or sponsored by the operator of the broadcast radio channel.

11. A method according to claim 1, wherein the service provided by the service system is a location-based service, the service request either including a request location or giving access authority to enable the service system to obtain the location of the source of the service request from a location server.

12. A method according to claim 1, wherein the communications infrastructure comprises a cellular radio network interfacing with the Internet, the service system being connected to the Internet whereby to receive service requests from mobile users having connectivity to the cellular radio network.

13. A method of obtaining use of a service system accessible via a data-capable bearer service of a communications infrastructure, the method comprising the steps of:
(a) receiving a broadcast radio channel that periodically includes, along with the content being broadcast, a variable-value access code;
(b) extracting the access code from the received broadcast radio channel;
(c) sending a service request to the service system via said data-capable bearer service, the service request including a recently broadcast access-code value.

14. A method according to claim 1, wherein the access-code value included in the request is the most recently received access-code value.

15. Apparatus for obtaining use of a service system accessible via a data-capable bearer service of a communications infrastructure, the apparatus comprising:
a radio receiver for receiving broadcast content that periodically includes a variable-value access code;
an extraction subsystem for extracting the access code from the received broadcast radio channel;
a request subsystem for generating a service request and sending it to the service system via said data-capable bearer service, the service request including a recently broadcast access-code value as extracted by the extraction subsystem.

16. Apparatus according to claim 15, wherein the access-code value included in the request is the most recently received access-code value.

17. A method of providing for controlled use of a service system accessible via a data-capable bearer service of a communications infrastructure, the method comprising the steps of:
(a) broadcasting content via a broadcast radio channel and periodically including a variable-value access code;
(b) receiving the broadcast radio channel;
(c) extracting the access code from the received broadcast radio channel;
(d) sending a service request to the service system via said data-capable bearer service, the service request including a recently broadcast access-code value; and
(e) receiving the service request at the service system and only servicing the request where the request is accompanied by a recently broadcast access-code value.

18. A method according to claim 17, wherein the service request is only serviced where the access-code value included in the request is the most recently broadcast access-code value.
